(19) United States
(12) Patent Application Publication
(10) Pub. No.: US 2025/0266941 A1
(43) Pub. Date: Aug. 21, 2025

(54) SIGNAL GENERATION METHOD, AND ELECTRONIC DEVICE AND STORAGE MEDIUM

(71) Applicant: ZTE CORPORATION, Shenzhen (CN)

(72) Inventors: Kun LIU, Shenzhen (CN); Weiwei YANG, Shenzhen (CN); Bo DAI, Shenzhen (CN); Mengzhu CHEN, Shenzhen (CN); Youjun HU, Shenzhen (CN)

(21) Appl. No.: 18/994,300

(22) PCT Filed: Jul. 20, 2023
(86) PCT No.: PCT/CN2023/108407

§ 371 Date: Jan. 14, 2025

(30) Foreign Application Priority Data
Aug. 31, 2022 (CN) 202211053984.0

(51) Int. Cl. H04L 5/00

(52) U.S. Cl. CPC H04L 5/0005; H04L 5/0098

(57) ABSTRACT

Provided are a signal generation method, an electronic device, and a storage medium. The method includes configuring a signal to occupy at least one time-domain symbol in the time domain and at least one subcarrier in the frequency domain, where the bandwidth in the frequency domain includes N subcarriers, and N is greater than or equal to 1; determining information carried on the N subcarriers.

This application claims priority to Chinese Patent Application No. 202211053984.0 filed with the China National Intellectual Property Administration (CNIPA) on Aug. 31, 2022, the disclosure of which is incorporated herein by reference in its entirety.

### TECHNICAL FIELD

The present application relates to the field of wireless communication technology, for example, a signal generation method, an electronic device, and a storage medium.

### BACKGROUND

With the development of wireless communication technology, there are increasingly higher requirements for device power consumption. In addition to latency, reliability, and availability, energy efficiency of user equipment (UE) is also critical in the fifth-generation mobile communication technology (5G) system. Currently, 5G devices may need to be charged weekly or daily based on individual usage time. Typically, 5G devices consume tens of milliwatts of power in the radio resource control (RRC) idle or inactive state and consume hundreds of milliwatts of power in the RRC connected state. How to extend battery life is a necessity for improving energy efficiency and enhancing user experience. Power consumption depends on the length of the configured wake-up cycle, such as the paging cycle. To meet battery life requirements, high-value extended discontinuous reception (eDRX) cycles are expected to be used, leading to high latency, which is not suitable for services that require both battery life and low latency. To improve battery life, the current field has introduced the ultra-low-power wake-up signal (LP-WUS) mechanism. That is, a user uses a separate receiver to receive a low-power wake-up signal. This wake-up signal is used to activate the main radio device for data transmission and reception. When the UE does not detect the low-power wake-up signal, the main receiver enters a deep sleep mode, thus further reducing the power consumption of the terminal. However, there is currently no method for generating a low-power wake-up signal.

### SUMMARY

The main objective of embodiments of the present application is to propose a signal generation method, an electronic device, and a storage medium to at least implement the generation of a low-power wake-up signal, enable ultra-low-power wake-up of devices in a deep sleep mode, reduce standby power consumption, and improve battery life of the devices.

Embodiments of the present application provide a signal generation method. The method includes the following.

A signal is configured to occupy at least one time-domain symbol in the time domain and at least one subcarrier in the frequency domain, where the bandwidth in the frequency domain includes N subcarriers, and N is greater than or equal to 1.

Information carried on the N subcarriers is determined.

Embodiments of the present application also provide an electronic device. The electronic device includes one or more processors and a memory configured to store one or more programs.

The one or more programs, when executed by the one or more processors, cause the one or more processors to perform the signal generation method according to any embodiment of the present application.

Embodiments of the present application also provide a computer-readable storage medium. The computer-readable storage medium stores one or more programs that, when executed by one or more processors, cause the one or more processors to perform the signal generation method according to any embodiment of the present application.

### BRIEF DESCRIPTION OF DRAWINGS

FIG. 1 is a flowchart of a signal generation method according to embodiments of the present application.

FIG. 2 is an example diagram of a signal generation method according to embodiments of the present application.

FIG. 3 is another example diagram of a signal generation method according to embodiments of the present application.

FIG. 4 is another example diagram of a signal generation method according to embodiments of the present application.

FIG. 5 is another example diagram of a signal generation method according to embodiments of the present application.

FIG. 6 is another example diagram of a signal generation method according to embodiments of the present application.

FIG. 7 is a diagram illustrating the structure of a signal generation apparatus according to embodiments of the present application.

FIG. 8 is a diagram illustrating the structure of an electronic device according to embodiments of the present application.

### DETAILED DESCRIPTION

It is to be understood that the specific embodiments described herein are intended to explain the present application and not to limit the present application.

Suffixes such as “module”, “component”, or “unit” used for indicating elements in the subsequent description are used for facilitating the description of the present application and have no particular meaning in themselves. Therefore, “module”, “component”, or “unit” can be used in a mixed manner.

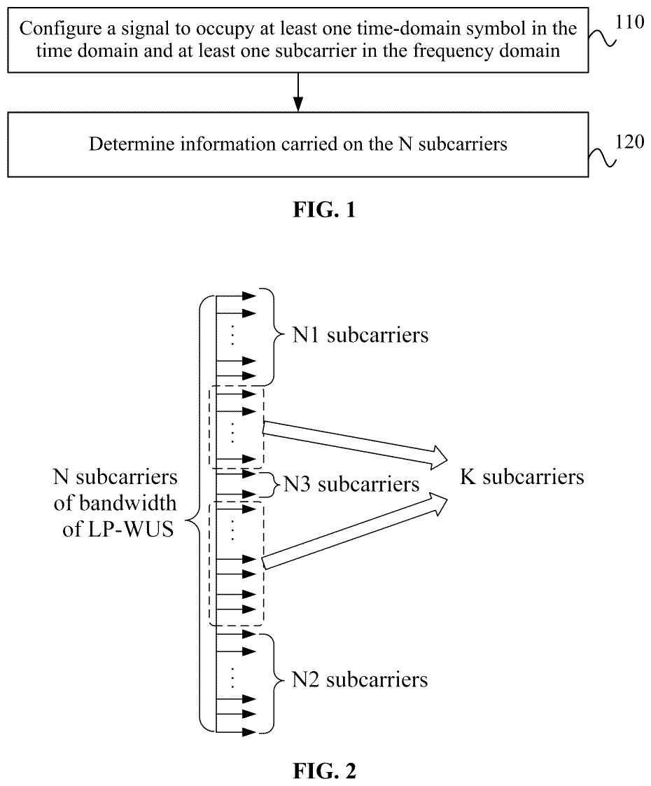

FIG. 1 is a flowchart of a signal generation method according to embodiments of the present application. The embodiments of the present application may be applied to the case of signal generation. The method may be performed by a signal generation apparatus. The apparatus may be implemented in software and/or hardware. With reference to FIG. 1, the method provided by the embodiments of the present application include the operations described below.

In S110, a signal is configured to occupy at least one time-domain symbol in the time domain and at least one subcarrier in the frequency domain, where the bandwidth in the frequency domain includes N subcarriers, and N is greater than or equal to 1.

In the embodiments of the present application, a signal that occupies at least one time-domain symbol in the time domain and at least one subcarrier in the frequency domain may be configured, and the signal may be used for ultra low-power wake-up. The bandwidth of the signal in the frequency domain may be composed of N subcarriers.

In S120, information carried on the N subcarriers is determined.

In the embodiments of the present application, the information carried on the N subcarriers occupied by the signal may be determined.

In some embodiments, determining the information carried on the N subcarriers includes at least one of the following: N1 subcarriers at the upper boundary of the bandwidth are used as a guard bandwidth, where N1 is greater than or equal to 0 and less than or equal to N; N2 subcarriers at the lower boundary of the bandwidth are used as a guard bandwidth, where N2 is greater than or equal to 0 and less than or equal to N; N3 subcarriers at the center of the N subcarriers are not filled with data or are filled with data of 0, where N3 is greater than or equal to 0 and less than or equal to N; or K subcarriers among the N subcarriers are filled with data, where K is greater than or equal to 1 and less than or equal to N.

In the embodiments of the present application, N1 subcarriers at the upper boundary of the bandwidth occupied by the signal are selected as the guard bandwidth, and N1 may be an integer greater than or equal to 0. It is understood that N1 is less than or equal to the total number N of subcarriers occupied by the signal. Correspondingly, in an embodiment, N2 subcarriers at the lower boundary of the bandwidth occupied by the signal may be selected as the guard bandwidth; N2 may be an integer greater than or equal to 0, and N2 may be less than or equal to N. In other embodiments, N3 subcarriers in the central part of the bandwidth occupied by the signal may be selected to not carry data or to be filled with zeros. In other embodiments, K subcarriers may be selected from N subcarriers to carry data, and it is understood that K may be less than or equal to N. On this basis, in some embodiments, one or more of the preceding embodiments may be combined to form the implementation.

In some embodiments, positions of the K subcarriers include at least one of the following: remaining subcarriers after removing the N1 subcarriers and the N2 subcarriers from the N subcarriers; or remaining subcarriers after removing the N1 subcarriers, the N2 subcarriers, and the N3 subcarriers from the N subcarriers.

In the embodiments of the present application, K subcarriers may be selected from the N subcarriers of the signal to carry data, and the K subcarriers may be the remaining subcarriers after removing the N1 and N2 subcarriers determined as the guard bandwidth in the preceding embodiments. In some other embodiments, the K subcarriers filled with data in the signal may be the remaining subcarriers after removing the subcarriers determined as the guard bandwidth and the subcarriers that are not filled with data or are filled with data of 0.

FIG. 2 is an example diagram of a signal generation method according to embodiments of the present application. With reference to FIG. 2, in the embodiment of the present application, an LP-WUS may occupy at least one time-domain symbol in the time domain, and the bandwidth occupied by the LP-WUS in the frequency domain may include N subcarriers. With reference to FIG. 2, among the N subcarriers, N1 and N2 subcarriers may be configured as the upper boundary guard bandwidth and the lower boundary guard bandwidth, respectively, where the guard bandwidth may not send information. N3 subcarriers at the center of the N subcarriers may also be selected to be not filled with data or be filled with data of 0. The remaining K subcarriers may be used to send the LP-WUS.

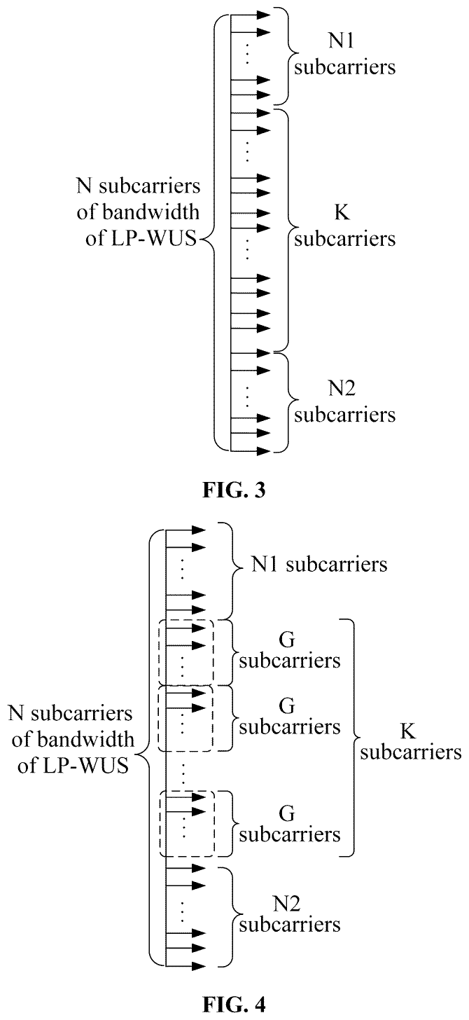

FIG. 3 is another example diagram of a signal generation method according to embodiments of the present application. With reference to FIG. 3, in the embodiments of the present application, an LP-WUS may occupy at least one time-domain symbol in the time domain, and the bandwidth occupied by the LP-WUS in the frequency domain may include N subcarriers. With reference to FIG. 3, among the N subcarriers, N1 and N2 subcarriers may be configured as the upper boundary guard bandwidth and the lower boundary guard bandwidth, respectively, where the guard bandwidth may not send information. The remaining K subcarriers may be used to send the LP-WUS.

In some embodiments, the method for determining positions of the K subcarriers includes the following: remaining subcarriers after removing the N1 subcarriers and the N2 subcarriers from the N subcarriers are divided into K subcarrier groups, where each subcarrier group includes G subcarriers, and G is an integer greater than or equal to 1; and one subcarrier is selected from each subcarrier group of the K subcarrier groups to form the K subcarriers.

In the embodiments of the present application, the K subcarriers may be determined by evenly dividing the remaining subcarriers, after removing the N1 subcarriers determined as the upper boundary guard bandwidth and the N2 subcarriers determined as the lower boundary guard bandwidth from the N subcarriers, into K subcarrier groups. Each subcarrier group may include G subcarriers, where G is an integer greater than or equal to 1. One subcarrier may be selected from each of the divided K subcarrier groups, and the selected K subcarriers may be used to be filled with data.

FIG. 4 is another example diagram of a signal generation method according to embodiments of the present application. With reference to FIG. 4, an LP-WUS may occupy at least one time-domain symbol in the time domain, the bandwidth occupied by the LP-WUS in the frequency domain may include N subcarriers, and N1 and N2 subcarriers in the N subcarriers may be configured as the upper boundary guard bandwidth and the lower boundary guard bandwidth, respectively, where the guard bandwidth may not send information. For the N subcarriers occupied by the signal, K subcarriers may be determined in the remaining subcarriers for being filled with data. The subcarriers after removing N1 and N2 are divided into K subcarrier groups, each subcarrier group includes G subcarriers, and one subcarrier is selected from each subcarrier group to form K subcarriers for being filled with data.

In some embodiments, the method for determining positions of the K subcarriers includes the following: the N subcarriers are divided into K subcarrier groups, where each subcarrier group includes G subcarriers, and G is an integer greater than or equal to 1; and one subcarrier is selected from each subcarrier group of the K subcarrier groups to form the K subcarriers.

In the embodiments of the present application, the N subcarriers occupied by the signal may be divided into K subcarrier groups, each subcarrier group may include G subcarriers, and one subcarrier may be selected from each of the K subcarrier groups to form the K subcarriers for being filled with data.

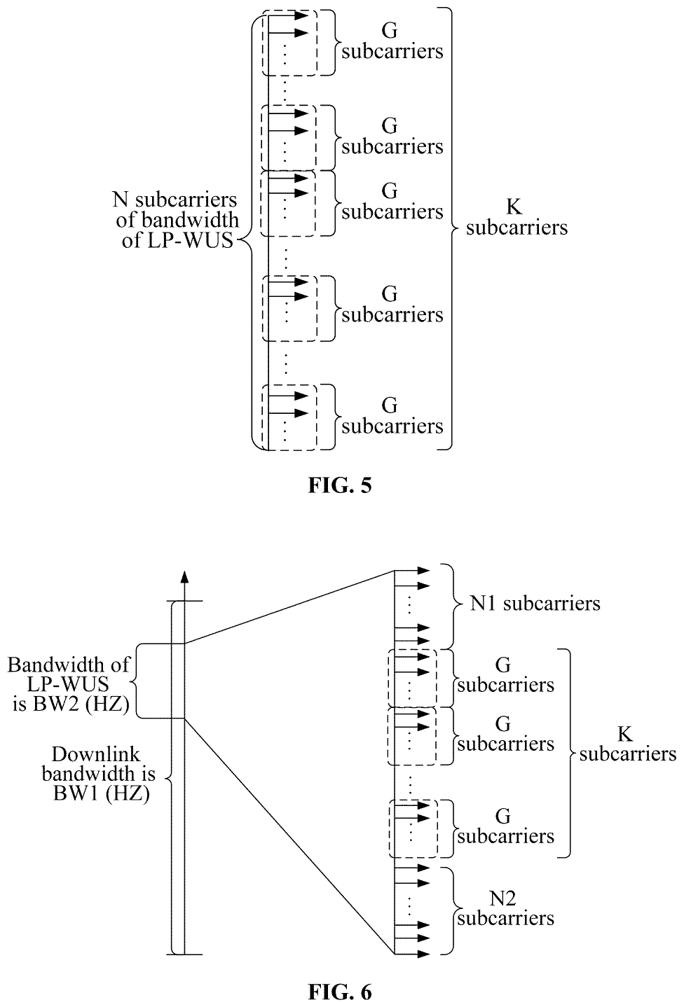

FIG. 5 is another example diagram of a signal generation method according to embodiments of the present application. With reference to FIG. 5, an LP-WUS may occupy at least one time-domain symbol in the time domain, and the bandwidth occupied by the LP-WUS in the frequency domain may include N subcarriers; the preceding N subcarriers may be divided into K subcarrier groups, each subcarrier group may include G subcarriers, and one subcarrier is selected from each subcarrier group to form K subcarriers for being filled with data.

In some embodiments, subcarriers forming the K subcarriers have the same index in their respective K subcarrier groups.

In the embodiments of the present application, the subcarriers determined to be filled with data may have the same index in their respective subcarrier groups.

In other embodiments, in the case where a selected subcarrier of the K subcarriers belongs to the N3 subcarriers, the selected subcarrier is not filled with data or is filled with data of 0.

In the embodiments of the present application, in the case where a subcarrier belongs to the selected K subcarriers and also belongs to the N3 subcarriers in the center of the N subcarriers that are not filled with data or are filled with data of 0, the subcarrier is not filled with data or is filled with data of 0.

In some other embodiments, in the case where a selected subcarrier of the K subcarriers belongs to the N1 subcarriers, the selected subcarrier is not filled with data or is filled with data of 0.

In the embodiments of the present application, for the selected K subcarriers for being filled with data, if one subcarrier among the K subcarriers falls within the range of the N1 subcarriers of the upper boundary guard bandwidth, the one subcarrier is not filled with data or is filled with data of 0.

In some other embodiments, in the case where a selected subcarrier of the K subcarriers belongs to the N2 subcarriers, the selected subcarrier is not filled with data or is filled with data of 0.

In the embodiments of the present application, for the selected K subcarriers, if the K subcarriers fall within the range of N2 subcarriers of the lower boundary guard bandwidth of the signal, the one subcarrier is not filled with data or is filled with data of 0.

In an embodiment, in the case where the signal supports at least two subcarrier spacings, the configuration of G includes the following: the subcarrier spacings include f_{sc} and 2⁻ⁿ·f_{sc}; in the case where a subcarrier spacing is 2⁻ⁿ·f_{sc} and G is configured as y, G is configured as y·2ⁿ in the case where the subcarrier spacing is 2⁻ⁿ·f_{sc}, where y is an integer greater than or equal to 1, and n is an integer greater than or equal to 1.

In the embodiments of the present application, the signal may support multiple subcarrier spacings, and the value of G in each subcarrier group may include the following: the subcarrier spacings include f_{sc} and 2⁻ⁿ·f_{sc}; in the case where a subcarrier spacing is f_{sc} and G is configured as y, G is configured as y·2ⁿ in the case where the subcarrier spacing is 2⁻ⁿ·f_{sc}, where y is an integer greater than or equal to 1, and n is an integer greater than or equal to 1.

In some embodiments, the configuration of G includes at least one of the following: in the case where the subcarrier spacing is 30 KHz and G is configured as 1, G is configured as 2 in the case where the subcarrier spacing is 15 KHz; or in the case where the subcarrier spacing is 60 KHz and G is configured as 1, G is configured as 2 in the case where the subcarrier spacing is 30 KHz, and G is configured as 4 in the case where the subcarrier spacing is 15 KHz.

FIG. 6 is another example diagram of a signal generation method according to embodiments of the present application. With reference to FIG. 6, in an orthogonal frequency-division multiplexing (OFDM) wireless communication system, the downlink channel system bandwidth is BW1 (Hz), and the transmission of low-power wake-up signals is supported. The LP-WUS occupies at least one time-domain symbol in the time domain, the bandwidth occupied by the LP WUS in the frequency domain is BW2 (BW2=1.08 MHz), the subcarrier spacing configured for the LP-WUS is 30 kHz, and then the LP-WUS occupies 36 subcarriers in the frequency domain. A physical resource block (PRB) may be defined to include 12 subcarriers, and then the LP-WUS occupies 3 PRBs in the frequency domain. As shown in FIG. 6, N1 and N2 (N1=N2=3) subcarriers are configured as guard bandwidth, where the guard bandwidth does not send information. 30 (36−3=30) subcarriers are present that can be used to send the LP-WUS. In this embodiment, G=1, that is, 30 subcarriers are occupied in the frequency domain for sending the LP WUS, that is, K=30. The data filled on the K (K=30) subcarriers is a sequence S₃₀ of length 30, marked as S₃₀=[s₀, s₁, s₂, s₃ . . . , s₂₉].

In another embodiment, when the subcarrier spacing configured for the LP-WUS is 15 kHz, the bandwidth occupied by the LP-WUS in the frequency domain is BW2 (BW2=1.08 MHz), and the LP-WUS occupies 72 subcarriers in the frequency domain. If N1 and N2 (N1=N2=6) subcarriers are configured as the guard bandwidth, the number of subcarriers that can be used to send the LP WUS is at most 60 (72−12=60).

In this embodiment, the LP-WUS also uses a sequence S₃₀ of length 30, where S₃₀=[s₀, s₁, s₂, s₃ . . . , s₂₉]. Since G=y=1 when the subcarrier spacing is 30 kHz, 30/15=2, and n=1, that is, G=y2ⁿ=1*2=2. In other words, each subcarrier group includes 2 subcarriers, and the UE selects one subcarrier in one subcarrier group as the subcarrier for sending LP-WUS. Then the number of subcarriers occupied in the frequency domain for sending LP-WUS is 30, and a sequence S₃₀ of length 30 is also used, where S₃₀=[s₀, s₁, s₂, s₃ . . . , s₂₉].

In some embodiments, the data filled on the K subcarriers is a sequence S of length 2*M, the sequence S is composed of two sequences each having a length of M, and S=[A_{M}, B_{M}].

A_{M} denotes a first sequence of length M, B_{M} denotes a second sequence of length M, and K=2*M.

A_{M} and B_{M} include at least one of the following: A_{M}=[a₀, a₁, a₂, a₃ . . . , a_{M-1}], and

$${B}_{M} = [ {b}_{0} , {b}_{1} , {b}_{2} , {b}_{3} , … , {b}_{M - 1} ] ; {A}_{M} = [ {a}_{0} , {a}_{1} , {a}_{2} , {a}_{3} … , {a}_{M - 1} ] and {B}_{M} = [ - {b}_{0} , - {b}_{1} , - {b}_{2} , - {b}_{3} , … , - {b}_{M - 1} ] ; {A}_{M} = [ - {a}_{0} , - {a}_{1} , - {a}_{2} , - {a}_{3} … , - {a}_{M - 1} ] , and {B}_{M} = [ {b}_{0} , {b}_{1} , {b}_{2} , {b}_{3} , … , {b}_{M - 1} ] ; or {A}_{M} = [ - {a}_{0} , - {a}_{1} , - {a}_{2} , - {a}_{3} … , - {a}_{M - 1} ] , and {B}_{M} = [ - {b}_{0} , - {b}_{1} , - {b}_{2} , - {b}_{3} , … , - {b}_{M - 1} ] .$$

A_{M} and B_{M} satisfy at least one of the following properties:
A_{M} and B_{M} are a Gray complementary sequence pair;
when A_{M} and B_{M} are real number sequences, Σₙ₌₀^{M-1}(aₙ·aₙ+bₙ·bₙ)=2M in the case where j=0;
when A_{M} and B_{M} are real number sequences, Σₙ₌₀^{M-1-j}(aₙ·aₙ₊ⱼ+bₙ·bₙ₊ⱼ)=0 in the case where j≠0;
when A_{M} and B_{M} are complex number sequences, Σₙ₌₀^{M-1}(aₙ·a′ₙ+bₙ·b′ₙ)=2M in the case where j=0, where a′ₙ is the conjugate of an, and b′ₙ is the conjugate of bₙ; or
when A_{M} and B_{M} are complex number sequences, Σₙ₌₀^{M-1-j}(aₙ·a′ₙ₊ⱼ+b·b′ₙ₊ⱼ)=0 in the case where j≠0, where a′ₙ₊ⱼ is the conjugate of aₙ₊ⱼ, and b′ₙ₊ⱼ is the conjugate of bₙ₊ⱼ.

In some other embodiments, the data filled on the K subcarriers is a sequence S of length 4*M, the sequence S is composed of two sequences each having a length of 2*M, and S=[A_{2*M}, B_{2*M}].

A_{2*M} denotes a first sequence of length 2*M, B_{2*M} denotes a second sequence of length 2*M, and K=4*M.

A_{2*M} and B_{2*M} include at least one of the following: A_{2*M}=[A_{M}, B_{M}], and B_{2*M}=[−A_{M}, B_{M}]; A_{2*M}=[A_{M}, B_{M}], and B_{2*M}=[−A_{M}, −B_{M}]; A_{2*M}=[−A_{M}, −B_{M}], and B_{2*M}=[−A_{M}, B_{M}]; or A_{2*M}=[−A_{M}, −B_{M}], and B_{2*M}=[A_{M}, −B_{M}].

A_{M} and B_{M} satisfy at least one of the following properties:
A_{M} and B_{M} are a Gray complementary sequence pair;
when A_{M} and B_{M} are real number sequences, Σₙ₌₀^{M-1}(aₙ·aₙ+bₙ·bₙ)=2M in the case where j=0;
when A_{M} and B_{M} are real number sequences, Σₙ₌₀^{M-1-j}(aₙ·aₙ₊ⱼ+b·bₙ₊ⱼ)=0 in the case where j≠0;
when A_{M} and B_{M} are complex number sequences, Σₙ₌₀^{M-1}(aₙ·a′ₙ+bₙ b′ₙ)=2M in the case where j=0; where a′ₙ is the conjugate of an, and b′ₙ is the conjugate of bₙ; or
when A_{M} and B_{M} are complex number sequences, Σₙ₌₀^{M-1-j}(aₙ·a′ₙ₊ⱼ+b·b′ₙ₊ⱼ)=0 in the case where j≠0; where a′ₙ₊ⱼ is the conjugate of aₙ₊ⱼ, and b′ₙ₊ⱼ is the conjugate of bₙ₊ⱼ.

In some embodiments, the data filled on the K subcarriers is a sequence S of length 8*M, the sequence S is composed of two sequences each having a length of 4*M, and S=[A_{4*M}, B_{4*M}].

A_{4*M} denotes a first sequence of length 4*M, B_{4*M} denotes a second sequence of length 4*M, and K=8*M.

A_{4*M} and B_{4*M} include at least one of the following: A_{4*M}=[A_{2*M}, B_{2*M}], and B_{4*M}=[−A_{2*M}, B_{2*M}]; A_{4*M}=[A_{2*M}, B_{2*M}], and B_{4*M}=[−A_{2*M}, −B_{2*M}]; A_{4*M}=[−A_{2*M}, −B_{2*M}], and B_{4*M}=[−A_{2*M}, B_{2*M}]; or A_{4*M}=[−A_{2*M}, −B_{2*M}], and B_{4*M}=[A_{2*M}, −B_{2*M}].

A_{2*M} and B_{2*M} include at least one of the following: A_{2*M}=[A_{M}, B_{M}], and B_{2*M}=[−A_{M}, B_{M}]; A_{2*M}=[A_{M}, B_{M}], and B_{2*M}=[−A_{M}, −B_{M}]; A_{2*M}=[−A_{M}, −B_{M}], and B_{2*M}=[−A_{M}, B_{M}]; or A_{2*M}=[−A_{M}, −B_{M}], and B_{2*M}=[A_{M}, −B_{M}].

A_{M} and B_{M} satisfy at least one of the following properties:
A_{M} and B_{M} are a Gray complementary sequence pair;
when A_{M} and B_{M} are real number sequences, Σₙ₌₀^{M-1}(aₙ·aₙ+bₙ·bₙ)=2M in the case where j=0;
when A_{M} and B_{M} are real number sequences, Σₙ₌₀^{M-1-j}(aₙ·aₙ₊ⱼ+bₙ·bₙ₊ⱼ)=0 in the case where j≠0;
when A_{M} and B_{M} are complex number sequences, Σₙ₌₀^{M-1} (aₙ·a′ₙ+bₙ·b′ₙ)=2M in the case where j=0; where a′ₙ is the conjugate of an, and b′ₙ is the conjugate of bₙ; or
when A_{M} and B_{M} are complex number sequences, Σₙ₌₀^{M-1-j}(aₙ·a′ₙ₊ⱼ+b·b′ₙ₊ⱼ)=0 in the case where j≠0; where a′ₙ₊ⱼ is the conjugate of aₙ₊ⱼ, and b′ₙ₊ⱼ is the conjugate of bₙ₊ⱼ.

In some other embodiments, the data filled on the K subcarriers is a sequence S of length 2ⁱ⁺²*M, the sequence S is composed of two sequences each having a length of 2ⁱ⁺¹*M, and S=[A₂_{ⁱ⁺¹}_{*M}, B₂_{ⁱ⁺¹}_{*M}].

A₂_{ⁱ⁺¹}_{*M} denotes a first sequence of length 2ⁱ⁺¹*M, and B₂_{ⁱ⁺¹}_{*M} denotes a second sequence of length 2ⁱ⁺¹*M.

K=2ⁱ⁺²*M, i is an integer greater than or equal to 0, and M is an integer greater than or equal to 1.

A₂_{ⁱ⁺¹}_{*M} and B₂_{ⁱ⁺¹}_{*M} include at least one of the following:

$${A}_{{2}^{i + 1} * M} = [ {A}_{{2}^{i} * M} , {B}_{{2}^{i} * M} ] , and {B}_{{2}^{i + 1} * M} = [ - {A}_{{2}^{i} * M} , {B}_{{2}^{i} * M} ] ;$$

$${A}_{{2}^{i + 1} * M} = [ {A}_{{2}^{i} * M} , {B}_{{2}^{i} * M} ] , and {B}_{{2}^{i - 1} * M} = [ - {A}_{{2}^{i} * M} , - {B}_{{2}^{i} * M} ] ;$$

$${A}_{{2}^{i + 1} * M} = [ - {A}_{{2}^{i} * M} , - {B}_{{2}^{i} * M} ] , and {B}_{{2}^{i + 1} * M} = [ - {A}_{{2}^{i} * M} , {B}_{{2}^{i} * M} ] ; or$$

$${A}_{{2}^{i + 1} * M} = [ - {A}_{{2}^{i} * M} , - {B}_{{2}^{i} * M} ] , and {B}_{{2}^{i + 1} * M} = [ {A}_{{2}^{i} * M} , - {B}_{{2}^{i} * M} ] ;$$

where i is an integer greater than or equal to 0.

In some embodiments, the first sequence and the second sequence are a Gray complementary sequence pair.

In some embodiments, the expression of the first sequence is A₂_{ⁱ⁺¹}_{*M}=[a₀, a₁, a₂, a₃ . . . , a_{P-1}], the expression of the second sequence is B₂_{ⁱ⁺¹}_{*M}=[b₀, b₁, b₂, b₃, . . . , b_{P-1}], and accordingly, the first sequence and the second sequence satisfy at least one of the following properties:
when the first sequence and the second sequence are real number sequences, Σₙ₌₀^{P-1}(aₙ·aₙ+bₙ·bₙ)=2P in the case where j=0;
when the first sequence and the second sequence are real number sequences, Σₙ₌₀^{P-1-j}(aₙ·aₙ₊ⱼ+bₙ·bₙ₊ⱼ)=0 in the case where j≠0;
when the first sequence and the second sequence are complex number sequences, Σₙ₌₀^{P-1}(aₙ·a′ₙ+bₙ·b′ₙ)=2P in the case where j=0; where a′ₙ is the conjugate of aₙ, and b′ₙ is the conjugate of bₙ; or
when the first sequence and the second sequence are complex number sequences, Σₙ₌₀^{P-1-j}(aₙ·a′ₙ₊ⱼ+bₙ·b′ₙ₊ⱼ)=0 in the case where j≠0; where a′ₙ₊ⱼ is the conjugate of aₙ₊ⱼ, and b′ₙ₊ⱼ is the conjugate of bₙ₊ⱼ;
where P=2ⁱ⁺¹*M, and i is an integer greater than or equal to 0.

In some other embodiments, the first sequence is A₂_{ⁱ}_{*M}=[a₀, a₁, a₂, a₃ . . . , a_{L-1}], the second sequence is B₂_{ⁱ}_{*M}=[b₀, b₁, b₂, b₃, . . . , b_{L=1}], and accordingly, the sequence A₂_{ⁱ}_{*M} and the sequence B₂_{ⁱ}_{*M} satisfy at least one of the following properties:
when the first sequence and the second sequence are real number sequences, Σₙ₌₀^{L-1}(aₙ·aₙ+bₙ·bₙ)=2L in the case where j=0;
when the first sequence and the second sequence are real number sequences, Σₙ₌₀^{L-1-j}(aₙ·aₙ₊ⱼ bₙ·bₙ₊ⱼ)=0 in the case where j≠0;
when the first sequence and the second sequence are complex number sequences, Σₙ₌₀^{L-1}(aₙ·a′ₙ+bₙ·b′ₙ)=2L in the case where j=0; where a′ₙ is the conjugate of aₙ, and b′ₙ is the conjugate of bₙ; or
when the first sequence and the second sequence are complex number sequences, Σₙ₌₀^{L-1-j}(aₙ·a′ₙ₊ⱼ+bₙ·b′ₙ₊ⱼ)=0 in the case where j≠0; where a′ₙ₊ⱼ is the conjugate of aₙ₊ⱼ, and b′ₙ₊ⱼ is the conjugate of bₙ₊ⱼ;
where L=2ⁱ*M, and i is an integer greater than or equal to 0.

In the embodiments of the present application, the frequency domain expansion scheme of the Gray complementary sequence is applied for K subcarrier. When K=2*M, the data filled on the K subcarriers is a sequence S_{2M} of length 2*M, marked as S_{2M}=[s₀, S₁, s₂, s₃ . . . , s_{2M-1}]. The sequence S_{2M} is composed of 2 sequences of length M, that is, sequence A_{M}=[a₀, a₁, a₂, a₃ . . . , a_{M-1}] and sequence B_{M}=[b₀, b₁, b₂, b₃, . . . , b_{M-1}], and the composition method includes at least one of the following:

$${S}_{2 M} = {S}_{2 M}^{1} = [ {A}_{M} , {B}_{M} ] , that is , [ {a}_{0} , {a}_{1} , {a}_{2} , {a}_{3} … , {a}_{M - 1} , {b}_{0} , {b}_{1} , {b}_{2} , {b}_{3} , … , {b}_{M - 1} ] ;$$

$${S}_{2 M} = {S}_{2 M}^{2} = [ {A}_{M} , - {B}_{M} ] , that is , [ {a}_{0} , {a}_{1} , {a}_{2} , {a}_{3} … , {a}_{M - 1} , - {b}_{0} , - {b}_{1} , - {b}_{2} , - {b}_{3} , … , - {b}_{M - 1} ] ;$$

$${S}_{2 M} = {S}_{2 M}^{3} = [ - {A}_{M} , {B}_{M} ] , that is , [ - {a}_{0} , - {a}_{1} , - {a}_{2} , - {a}_{3} … , - {a}_{M - 1} , {b}_{0} , {b}_{1} , {b}_{2} , {b}_{3} , … , {b}_{M - 1} ] ; or$$

$${S}_{2 M} = {S}_{2 M}^{4} = [ - {A}_{M} , - {B}_{M} ] , that is , [ - {a}_{0} , - {a}_{1} , - {a}_{2} , - {a}_{3} … , - {a}_{M - 1} , - {b}_{0} , - {b}_{1} , - {b}_{2} , - {b}_{3} , … , - {b}_{M - 1} ] .$$

In an embodiment, A_{M} and B_{M} are a Gray complementary sequence pair.

In an embodiment, A_{M} and B_{M} satisfy the following properties:
it is defined that the sequence A=[a₀, a₁, a₂, a₃ . . . , a_{M-1}] and the sequence B=[b₀, b₁, b₂, b₃, . . . , b_{M-1}], then

$$when j = 0 , {\sum }_{n = 0}^{M - 1} ( {a}_{n} \cdot {a}_{n} + {b}_{n} \cdot {b}_{n} ) = 2 M ; \qquad ( 1 )$$

$$when j \neq 0 , {\sum }_{n = 0}^{M - 1 - j} ( {a}_{n} \cdot {a}_{n + j} + {b}_{n} \cdot {b}_{n + j} ) = 0 . \qquad ( 2 )$$

In some embodiments, when K=4*M, the data filled on K subcarriers is a sequence S_{4M} of length 4*M, marked as S_{4M}=[s₀, s₁, s₂, s₃ . . . , s_{4M-1}]. The sequence S_{4M} is composed of 2 sequences each having a length of 2*M, that is, the sequence S_{4M} is composed of the sequence C_{2M} and the sequence D_{2M}, that is, S_{4M}=[C_{2M}, D_{2M}].

The sequence C_{2M} and the sequence D_{2M} are at least one of the following:
the sequence C_{2M}=[A_{M}, B_{M}], andthe sequence D_{2M}=[−A_{M}, B_{M}];
the sequence C_{2M}=[A_{M}, B_{M}], and the sequence D_{2M}=[A_{M}, −B_{M}];
the sequence C_{2M}=[−A_{M}, −B_{M}], and the sequence D_{2M}=[A_{M}, −B_{M}]; or
the sequence C_{2M}=[−A_{M}, −B_{M}], and the sequence D_{2M}=[−A_{M}, B_{M}].

In some embodiments, when K=8*M, the data filled on K subcarriers is a sequence S_{8M} of length 8*M, marked as S_{8M}=[s₀, s₁, s₂, s₃ . . . , s_{8M-1}]. The sequence S_{8M} is composed of 2 sequences each having a length of 4*M, that is, the sequence S_{8M} is composed of the sequence E_{4M} and the sequence F_{4M}, that is. S_{8M}=[E_{4M}, F₄M].

The sequence E_{4M} and the sequence F_{4M} are at least one of the following:
the sequence E_{4M}=[C_{2M}, D_{2M}], and the sequence F_{4M}=[−C_{2M}, D_{2M}];
the sequence E_{4M}=[C_{2M}, D_{2M}], and the sequence F_{4M}=[C_{2M}, −D_{2M}];
the sequence E_{4M}=[−C_{2M}, −D_{2M}], and the sequence F_{4M}=[C_{2M}, −D_{2M}]; or the sequence E_{4M}=[−C_{2M}, −D_{2M}], and the sequence F_{4M}=[−C_{2M}, D_{2M}].

For example, when K=2ⁱ⁺²*M, the data filled on the K subcarriers is [A₂_{ⁱ⁺¹}_{*M}, B₂_{ⁱ⁺¹}_{*M}], where A₂_{ⁱ⁺¹}_{*M} and B₂_{ⁱ⁺¹}_{*M} are at least one of the following:

$${A}_{{2}^{i + 1} * M} = [ {A}_{{2}^{i} * M} , {B}_{{2}^{i} * M} ] , and {B}_{{2}^{i + 1} * M} = [ - {A}_{{2}^{i} * M} , {B}_{{2}^{i} * M} ] ;$$

$${A}_{{2}^{i + 1} * M} = [ {A}_{{2}^{i} * M} , {B}_{{2}^{i} * M} ] , and {B}_{{2}^{i + 1} * M} = [ - {A}_{{2}^{i} * M} , - {B}_{{2}^{i} * M} ] ;$$

$${A}_{{2}^{i + 1} * M} = [ - {A}_{{2}^{i} * M} , - {B}_{{2}^{i} * M} ] , and {B}_{{2}^{i + 1} * M} = [ - {A}_{{2}^{i} * M} , {B}_{{2}^{i} * M} ] ; or$$

$${A}_{{2}^{i + 1} * M} = [ - {A}_{{2}^{i} * M} , - {B}_{{2}^{i} * M} ] , and {B}_{{2}^{i + 1} * M} = [ {A}_{{2}^{i} * M} , - {B}_{{2}^{i} * M} ] ;$$

where i is an integer greater than or equal to 0.

When i=0, A₂_{ⁱ}_{*M} and B₂_{ⁱ}_{*M} are A_{M} and B_{M}, and A_{M} and B_{M} satisfies at least one of the following:
A_{M} and B_{M} are a Gray complementary sequence pair; or
A_{M} and the sequence B_{M} satisfy the following properties: it is defined that the sequence A=[a₀, a₁, a₂, a₃ . . . , a_{M-1}] and the sequence B=[b₀, b₁, b₂, b₃, . . . , b_{M-1}], then

$$when j = 0 , {\sum }_{n = 0}^{M - 1} ( {a}_{n} \cdot {a}_{n} + {b}_{n} \cdot {b}_{n} ) = 2 M ; \qquad ( 1 )$$

$$when j \neq 0 , {\sum }_{n = 0}^{M - 1 - j} ( {a}_{n} \cdot {a}_{n + j} + {b}_{n} \cdot {b}_{n + j} ) = 0 . \qquad ( 2 )$$

In some embodiments, the data filled on the K subcarriers is a sequence S of length 2*M, the sequence S is composed of two sequences each having a length of M, and S=[A_{M}, B_{M}].

A_{M} denotes a first sequence of length M, B_{M} denotes a second sequence of length M, and K=2*M.

A_{M} and B_{M} include at least one of the following:

$${A}_{M} = [ {e}^{j {θ}_{1}} {a}_{0} , {e}^{j {θ}_{1}} {a}_{1} , {e}^{j {θ}_{1}} {a}_{2} , {e}^{j {θ}_{1}} {a}_{3} … , {e}^{j {θ}_{1}} {a}_{M - 1} ] ; and$$

$${B}_{M} = [ {e}^{j {θ}_{2}} {b}_{0} , {e}^{j {θ}_{2}} {b}_{1} , {e}^{j {θ}_{2}} {b}_{2} , {e}^{j {θ}_{2}} {b}_{3} , … , {e}^{j {θ}_{2}} {b}_{M - 1} ] .$$

In some other embodiments, the data filled on the K subcarriers is a sequence S of length 4*M, the sequence S is composed of two sequences each having a length of 2*M, and S=[A_{2*M}, B_{2*M}].

A_{2*M} denotes a first sequence of length 2*M, B_{2*M} denotes a second sequence of length 2*M, and K=4*M.

A_{2*M} and B_{2*M} include the following: A_{2*M}=[e^{jθ}^{₁}A_{M}, e^{jθ}^{₂}B_{M}], and B_{2*M}=[e^{jθ}^{₃}A_{M}, e^{jθ}^{₄}B_{M}]; where (θ1−θ2)−(θ3−θ4)=Q*180° or |θ1−θ2|−|θ3−θ4|=Q*180°, and Q is an integer, and θ1, θ2, θ3, and θ4 are real numbers.

In some embodiments, the data filled on the K subcarriers is a sequence S of length 8*M, the sequence S is composed of two sequences each having a length of 4*M, and S=[A_{4*M}, B_{4*M}].

A_{4*M} denotes a first sequence of length 4*M, B_{4*M} denotes a second sequence of length 4*M, and K=8*M.

A_{4*M} and B_{4*M} include the following: A_{4*M}=[e^{jθ}^{₅}A_{2*M}, e^{jθ}^{₆}B_{2*M}], and B_{4*M}=[e^{jθ}^{₇}A_{2*M}, e^{jθ}^{₈}B_{2*M}], where (θ5−θ6)−(θ7−θ8)=Q*180° or |θ5−θ6|−|θ7−θ8|=Q*180°, and Q is an integer.

In some other embodiments, the data filled on the K subcarriers is a sequence S of length 2ⁱ⁺²*M, the sequence S is composed of two sequences each having a length of 2ⁱ⁺¹*M, and S=[A₂_{ⁱ⁺¹}_{*M}, B₂_{ⁱ⁺¹}_{*M}].

A₂_{ⁱ⁺¹}_{*M} denotes a first sequence of length 2ⁱ⁺¹*M, and B₂_{ⁱ⁺¹}_{*M} denotes a second sequence of length 2ⁱ⁺¹*M.

K=2ⁱ⁺²*M, i is an integer greater than or equal to 0, and M is an integer greater than or equal to 1.

A₂_{ⁱ⁺¹}_{*M} and B₂_{ⁱ⁺¹}_{*M} include at least one of the following:

$${A}_{{2}^{i + 1} * M} = [ {e}^{j {θ}_{1}^{i}} {A}_{{2}^{i} * M} , {e}^{j {θ}_{2}^{i}} {B}_{{2}^{i} * M} ] , and {B}_{{2}^{i + 1} * M} = [ {e}^{j {θ}_{3}^{i}} {A}_{{2}^{i} * M} , {e}^{j {θ}_{4}^{i}} {B}_{{2}^{i} * M} ] ;$$

where (θ₁ⁱ−θ₂ⁱ)−(θ₃ⁱ−θ₄ⁱ)=Q*180° or |θ₁ⁱ−θ₂ⁱ|−|θ₃ⁱ−θ₄ⁱ|=Q*180°, and Q is an integer.

In some embodiments, the first sequence and the second sequence are a Gray complementary sequence pair.

In some embodiments, the expression of the first sequence is A₂_{ⁱ⁺¹}_{*M}=[a₀, a₁, a₂, a₃ . . . , a_{P-1}], the expression of the second sequence is B₂_{ⁱ⁺¹}_{*M}=[b₀, b₁, b₂, b₃, . . . , b_{P-1}], and accordingly, the first sequence and the second sequence satisfy at least one of the following properties:

$$in the case where j = 0 , {\sum }_{n = 0}^{P - 1} ( {a}_{n} \cdot {a}_{n} + {b}_{n} \cdot {b}_{n} ) = 2 P ; or$$

$$in the case where j \neq 0 , {\sum }_{n = 0}^{P - 1 - j} ( {a}_{n} \cdot {a}_{n + j} + {b}_{n} \cdot {b}_{n + j} ) = 0 ;$$

where P=2ⁱ⁺¹*M, and i is an integer greater than or equal to 0.

In some other embodiments, the first sequence is A₂_{ⁱ}_{*M}=[a₀, a₁, a₂, a₃ . . . , a_{L-1}], the second sequence is B₂_{ⁱ}_{*M}=[b₀, b₁, b₂, b₃, . . . , b_{L-1}], and accordingly, the sequence A₂_{ⁱ}_{*M} and the sequence B₂_{ⁱ}_{*M} satisfy at least one of the following properties:

$$in the case where j = 0 , {\sum }_{n = 0}^{L - 1} ( {a}_{n} \cdot {a}_{n} + {b}_{n} \cdot {b}_{n} ) = 2 L ; or$$

$$in the case where j \neq 0 , {\sum }_{n = 0}^{L - 1 - j} ( {a}_{n} \cdot {a}_{n + j} + {b}_{n} \cdot {b}_{n + j} ) = 0 ;$$

where L=2ⁱ*M, and i is an integer greater than or equal to 0.

In some embodiments, in the case where K=2^{y}*M+X, where y is an integer greater than or equal to 0, M is an integer greater than or equal to 1, and X is an integer greater than or equal to 1, the method also includes the following: generating a sequence S of length 2^{y}*M and a sequence S_{X} of length X; and filling the K subcarriers based on the sequence S_{X} and the sequence S.

In the embodiments of the present application, in the case where the value of K is not an integer multiple of 2M, in an example embodiment, K is (2^{y}*M+X), a sequence S of length 2^{y}*M and a sequence S_{X} of length X may be generated first, and K subcarriers may be filled based on the sequence S_{X} and sequence S.

In some embodiments, generating the sequence S_{X} of length X includes at least one of the following: generating the sequence S_{X} of all zeros of length X; randomly generating the sequence S_{X} of length X; generating the sequence S_{X} of length X according to a preset formula; forming the sequence S_{X} by the first X elements in the sequence S; forming the sequence S_{X} by the last X elements in the sequence S; or forming the sequence S_{X} by selecting X elements from the sequence S.

In some other embodiments, filling the K subcarriers based on the sequence S_{X} and the sequence S includes generating a sequence SK of length K, where the generation of the sequence S_{X} includes at least one of the following: S_{K}=[S, S_{X}]; or S_{K}=[S_{X}, S].

In some embodiments, on the basis that the data filled on the K subcarriers is the sequence SK, a deformation of SK is performed, and the deformation includes at least one of the following:
a unified scrambling code is added to the sequence S_{K}, that is, each element in the S_{K} needs to be multiplied by a certain variable, and the value of the variable is determined by at least one of the following: the time-domain symbol where the subcarrier is located; the frequency domain position where the K subcarriers are located; or the index information of the base station or cell that sends the sequence S_{K};
scrambling codes are added to the sequence S_{K} based on respective subcarriers, that is, elements in the S_{K} need to be multiplied by respective certain variables, and a value of a respective variable is at least determined by the index of a subcarrier where an element is located; or
an offset is added to the sequence S_{K}, that is, each element in the S_{K} needs to be added or subtracted by a certain offset, and the value of the offset is the same value for each subcarrier or at least determined by the index of the subcarrier where the element is located.

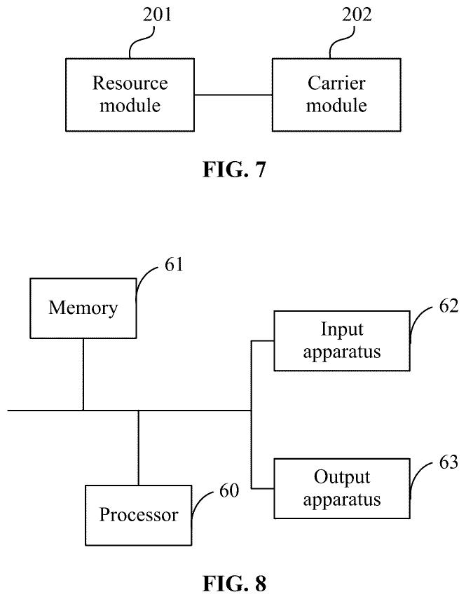

FIG. 7 is a diagram illustrating the structure of a signal generation apparatus according to embodiments of the present application. The apparatus may perform the signal generation method according to any embodiment of the present application and has the functional modules and beneficial effects corresponding to the applied method. The apparatus may be implemented by software and/or hardware. As shown in FIG. 7, the apparatus provided in the embodiments of the present application mainly includes a resource module 201 and a carrier module 202.

The resource module 201 is configured to configure a signal to occupy at least one time-domain symbol in the time domain and at least one subcarrier in the frequency domain, where the bandwidth in the frequency domain includes N subcarriers, and N is greater than or equal to 1.

The carrier module 202 is configured to determine information carried on the N subcarriers.

In the embodiment of the present application, the resource module configures the time-domain symbol and subcarriers occupied by the signal in the time domain and the frequency domain, and the carrier module determines the information carried on the N subcarriers, so as to at least implement the generation of a low-power wake-up signal, enable ultra-low-power wake-up of devices in a deep sleep mode, reduce standby power consumption, and improve battery life of the devices.

In some embodiments, the carrier module 202 is configured to determine at least one of the following: N1 subcarriers at the upper boundary of the bandwidth are used as a guard bandwidth, where N1 is greater than or equal to 0 and less than or equal to N; N2 subcarriers at the lower boundary of the bandwidth are used as a guard bandwidth, where N2 is greater than or equal to 0 and less than or equal to N; N3 subcarriers at the center of the N subcarriers are not filled with data or are filled with data of 0, where N3 is greater than or equal to 0 and less than or equal to N; or K subcarriers among the N subcarriers are filled with data, where K is greater than or equal to 1 and less than or equal to N.

In some embodiments, positions of the K subcarriers include at least one of the following: remaining subcarriers after removing the N1 subcarriers and the N2 subcarriers from the N subcarriers; or remaining subcarriers after removing the N1 subcarriers, the N2 subcarriers, and the N3 subcarriers from the N subcarriers.

In some embodiments, the method for determining positions of the K subcarriers includes the following: remaining subcarriers after removing the N1 subcarriers and the N2 subcarriers from the N subcarriers are divided into K subcarrier groups, where each subcarrier group includes G subcarriers, and G is an integer greater than or equal to 1; and one subcarrier is selected from each subcarrier group of the K subcarrier groups to form the K subcarriers.

In some embodiments, the method for determining positions of the K subcarriers includes the following: the N subcarriers are divided into K subcarrier groups, where each subcarrier group includes G subcarriers, and G is an integer greater than or equal to 1; and one subcarrier is selected from each subcarrier group of the K subcarrier groups to form the K subcarriers.

In some embodiments, subcarriers forming the K subcarriers have the same index in their respective K subcarrier groups.

In some embodiments, in the case where a selected subcarrier of the K subcarriers belongs to the N3 subcarriers, the selected subcarrier is not filled with data or is filled with data of 0.

In some embodiments, in the case where a selected subcarrier of the K subcarriers belongs to the N1 subcarriers, the selected subcarrier is not filled with data or is filled with data of 0.

In some embodiments, in the case where a selected subcarrier of the K subcarriers belongs to the N2 subcarriers, the selected subcarrier is not filled with data or is filled with data of 0.

In some embodiments, in the case where the signal supports at least two subcarrier spacings, the configuration of G includes the following: the subcarrier spacings include f_{sc} and 2⁻ⁿ·f_{sc}; in the case where a subcarrier spacing is f_{sc} and G is configured as y, G is configured as y·2ⁿ in the case where the subcarrier spacing is 2⁻ⁿ·f_{sc}, where y is an integer greater than or equal to 1, and n is an integer greater than or equal to 1.

In some embodiments, the configuration of G includes at least one of the following: in the case where the subcarrier spacing is 30 KHz, G is configured as 1, G is configured as 2 in the case where the subcarrier spacing is 15 KHz; or
in the case where the subcarrier spacing is 60 KHz, G is configured as 1, G is configured as 2 in the case where the subcarrier spacing is 30 KHz, and G is configured as 4 in the case where the subcarrier spacing is 15 KHz.

In some embodiments, the data filled on the K subcarriers is a sequence S of length 2*M, the sequence S is composed of two sequences each having a length of M, and S=[A_{M}, B_{M}].

A_{M} denotes a first sequence of length M, B_{M} denotes a second sequence of length M, and K=2*M.

In some embodiments, A_{M} and B_{M} include at least one of the following:

$${A}_{M} = [ {a}_{0} , {a}_{1} , {a}_{2} , {a}_{3} … , {a}_{M - 1} ] , and {B}_{M} = [ {b}_{0} , {b}_{1} , {b}_{2} , {b}_{3} , … , {b}_{M - 1} ] ;$$

$${A}_{M} = [ {a}_{0} , {a}_{1} , {a}_{2} , {a}_{3} … , {a}_{M - 1} ] , and {B}_{M} = [ - {b}_{0} , - {b}_{1} , - {b}_{2} , - {b}_{3} , … , - {b}_{M - 1} ] ;$$

$${A}_{M} = [ - {a}_{0} , - {a}_{1} , - {a}_{2} , - {a}_{3} … , - {a}_{M - 1} ] , and {B}_{M} = [ {b}_{0} , {b}_{1} , {b}_{2} , {b}_{3} , … , {b}_{M - 1} ] ; or$$

$${A}_{M} = [ - {a}_{0} , - {a}_{1} , - {a}_{2} , - {a}_{3} … , - {a}_{M - 1} ] , and {B}_{M} = [ - {b}_{0} , - {b}_{1} , - {b}_{2} , - {b}_{3} , … , - {b}_{M - 1} ] .$$

In some other embodiments, A_{M} and B_{M} include the following:

$${A}_{M} = [ {e}^{j {θ}_{1}} {a}_{0} , {e}^{j {θ}_{1}} {a}_{1} , {e}^{j {θ}_{1}} {a}_{2} , {e}^{j {θ}_{1}} {a}_{3} … , {e}^{j {θ}_{1}} {a}_{M - 1} ] , and$$

$${B}_{M} = [ {e}^{j {θ}_{2}} {b}_{0} , {e}^{j {θ}_{2}} {b}_{1} , {e}^{j {θ}_{2}} {b}_{2} , {e}^{j {θ}_{2}} {b}_{3} , … , {e}^{j {θ}_{2}} {b}_{M - 1} ] .$$

In some embodiments, the data filled on the K subcarriers is a sequence S of length 4*M, the sequence S is composed of two sequences each having a length of 2*M, and S=[A_{2*M}, B_{2*M}].

A_{2*M} denotes a first sequence of length 2*M, B_{2*M} denotes a second sequence of length 2*M, and K=4*M.

In some embodiments, A_{2*M} and B_{2*M} include at least one of the following:

$${A}_{2 * M} = [ {A}_{M} , {B}_{M} ] , and {B}_{2 * M} = [ - {A}_{M} , {B}_{M} ] ;$$

$${A}_{2 * M} = [ {A}_{M} , {B}_{M} ] , and {B}_{2 * M} = [ - {A}_{M} , - {B}_{M} ] ;$$

$${A}_{2 * M} = [ - {A}_{M} , - {B}_{M} ] , and {B}_{2 * M} = [ - {A}_{M} , {B}_{M} ] ; or$$

$${A}_{2 * M} = [ - {A}_{M} , - {B}_{M} ] , and {B}_{2 * M} = [ {A}_{M} , - {B}_{M} ] .$$

In some other embodiments, A_{2*M} and B_{2*M} include the following: A_{2*M}=[e^{jθ}^{₁}A_{M}, e^{jθ}^{₂}B_{M}], and B_{2*M}=[e^{jθ}^{₃}A_{M}, e^{jθ}^{₄}B_{M}];
where (θ1−θ2)−(θ3−θ4)=Q*180° or |θ1−θ2|−|θ3−θ4|=Q*180°, and Q is an integer.

In some embodiments, the data filled on the K subcarriers is a sequence S of length 8*M, the sequence S is composed of two sequences each having a length of 4*M, and S=[A_{4*M}, B_{4*M}].

A_{4*M} denotes a first sequence of length 4*M, B_{4*M} denotes a second sequence of length 4*M, and K=8*M.

In some embodiments, A_{4*M} and B_{4*M} include at least one of the following:

$${A}_{4 * M} = [ {A}_{2 * M} , {B}_{2 * M} ] , and {B}_{4 * M} = [ - {A}_{2 * M} , {B}_{2 * M} ] ;$$

$${A}_{4 * M} = [ {A}_{2 * M} , {B}_{2 * M} ] , and {B}_{4 * M} = [ - {A}_{2 * M} , - {B}_{2 * M} ] ;$$

$${A}_{4 * M} = [ - {A}_{2 * M} , - {B}_{2 * M} ] , and {B}_{4 * M} = [ - {A}_{2 * M} , {B}_{2 * M} ] ; or$$

$${A}_{4 * M} = [ - {A}_{2 * M} , - {B}_{2 * M} ] , and {B}_{4 * M} = [ {A}_{2 * M} , - {B}_{2 * M} ] .$$

In some other embodiments, A_{4*M} and B_{4*M} include the following:

$${A}_{4 * M} = [ {e}^{j {θ}_{5}} {A}_{2 * M} , {e}^{j {θ}_{6}} {B}_{2 * M} ] , and {B}_{4 * M} = [ {e}^{j {θ}_{7}} {A}_{2 * M} , {e}^{j {θ}_{8}} {B}_{2 * M} ] ;$$

where (θ5−θ6)−(θ7−θ8)=Q*180° or |θ5−θ6|−|θ7−θ8|=Q*180°, and Q is an integer.

In some embodiments, the data filled on the K subcarriers is a sequence S of length 2ⁱ⁺²*M, the sequence S is composed of two sequences each having a length of 2ⁱ⁺¹*M, and S=[A₂_{ⁱ⁺¹}_{*M}, B₂_{ⁱ⁺¹}_{*M}].

A₂_{ⁱ⁺¹}_{*M} denotes a first sequence of length 2ⁱ⁺¹*M, and B₂_{ⁱ⁺¹}_{*M} denotes a second sequence of length 2ⁱ⁺¹*M; where K=2i+²*M, i is an integer greater than or equal to 0, and M is an integer greater than or equal to 1.

In some embodiments, A₂_{ⁱ⁺¹}_{*M} and B₂_{ⁱ⁺¹}_{*M} include at least one of the following:

$${A}_{{2}^{i + 1} * M} = [ {A}_{{2}^{i} * M} , {B}_{{2}^{i} * M} ] , and {B}_{{2}^{i + 1} * M} = [ - {A}_{{2}^{i} * M} , {B}_{{2}^{i} * M} ] ;$$

$${A}_{{2}^{i + 1} * M} = [ {A}_{{2}^{i} * M} , {B}_{{2}^{i} * M} ] , and {B}_{{2}^{i + 1} * M} = [ - {A}_{{2}^{i} * M} , - {B}_{{2}^{i} * M} ] ;$$

$${A}_{{2}^{i + 1} * M} = [ - {A}_{{2}^{i} * M} , - {B}_{{2}^{i} * M} ] , and {B}_{{2}^{i + 1} * M} = [ - {A}_{{2}^{i} * M} , {B}_{{2}^{i} * M} ] ; or$$

$${A}_{{2}^{i + 1} * M} = [ - {A}_{{2}^{i} * M} , - {B}_{{2}^{i} * M} ] , and {B}_{{2}^{i + 1} * M} = [ {A}_{{2}^{i} * M} , - {B}_{{2}^{i} * M} ] ;$$

where i is an integer greater than or equal to 0.

In some other embodiments, A₂_{ⁱ⁺¹}_{*M} and B₂_{ⁱ⁺¹}_{*M} include at least one of the following:

$${A}_{{2}^{i + 1} * M} = [ {e}^{j {θ}_{1}^{i}} {A}_{{2}^{i} * M} , {e}^{j {θ}_{2}^{i}} {B}_{{2}^{i} * M} ] , and {B}_{{2}^{i + 1} * M} = [ {e}^{j {θ}_{3}^{i}} {A}_{{2}^{i} * M} , {e}^{j {θ}_{4}^{i}} {B}_{{2}^{i} * M} ] ;$$

where (θ₁ⁱ−θ₂ⁱ)−(θ₃ⁱ−θ₄ⁱ)=Q*180° or |₁ⁱ−θ₂ⁱ|−|θ₃ⁱ−θ₄ⁱ|=Q*180°, and Q is an integer.

In some embodiments, the first sequence and the second sequence are a Gray complementary sequence pair.

In some embodiments, the first sequence is A₂_{ⁱ⁺¹}_{*M}=[a₀, a₁, a₂, a₃ . . . , a_{P-1}], the second sequence is B₂_{ⁱ⁺¹}_{*M}=[b₀, b₁, b₂, b₃, . . . , b_{P-1}], and accordingly, the first sequence and the second sequence satisfy at least one of the following properties:

$$in the case where j = 0 , {\sum }_{n = 0}^{P - 1} ( {a}_{n} \cdot {a}_{n} + {b}_{n} \cdot {b}_{n} ) = 2 P ; or$$

$$in the case where j \neq 0 , {\sum }_{n = 0}^{P - 1 - j} ( {a}_{n} \cdot {a}_{n + j} + {b}_{n} \cdot {b}_{n + j} ) = 0 ;$$

where P=2ⁱ⁺¹*M, and i is an integer greater than or equal to 0.

In some other embodiments, the first sequence is A₂_{ⁱ}_{*M}=[a₀, a₁, a₂, a₃ . . . , a_{L-1}], the second sequence is B₂_{ⁱ}_{*M}=[b₀, b₁, b₂, b₃, . . . , b_{L-1}], and accordingly, the sequence A₂_{ⁱ}_{*M} and the sequence B₂_{ⁱ}_{*M} satisfy at least one of the following properties:

$$in the case where j = 0 , {\sum }_{n = 0}^{L - 1} ( {a}_{n} \cdot {a}_{n} + {b}_{n} \cdot {b}_{n} ) = 2 L ; or$$

$$in the case where j \neq 0 , {\sum }_{n = 0}^{L - 1 - j} ( {a}_{n} \cdot {a}_{n + j} + {b}_{n} \cdot {b}_{n + j} ) = 0 ;$$

where L=2ⁱ*M, and i is an integer greater than or equal to 0.

In some embodiments, in the case where K=2^{y}*M+X, where y is an integer greater than or equal to 0, M is an integer greater than or equal to 1, and X is an integer greater than or equal to 1, the method also includes the following: generating a sequence S of length 2^{y}*M and a sequence S_{X} of length X; filling the K subcarriers based on the sequence S_{X} and the sequence S.

In some embodiments, generating the sequence S_{X} of length X includes at least one of the following: generating the sequence S_{X} of all zeros of length X; randomly generating the sequence S_{X} of length X; generating the sequence S_{X} of length X according to a preset formula; forming the sequence S_{X} by the first X elements in the sequence S; forming the sequence S_{X} by the last X elements in the sequence S; or forming the sequence S_{X} by selecting X elements from the sequence S.

In some other embodiments, filling the K subcarriers based on the sequence S_{X} and the sequence S includes generating a sequence SK of length K, where the generation of the sequence S_{K} includes at least one of the following: S_{K}=[S, S_{X}]; or S_{K}=[S_{X}, S].

FIG. 8 is a diagram illustrating the structure of an electronic device according to embodiments of the present application. The electronic device includes a processor 60 and a memory 61. One or more processors 60 may be provided in the electronic device. One processor 60 is used as an example in FIG. 8. The processor 60 and the memory 61 in the electronic device may be connected through a bus or in other manners. In FIG. 8, connection through a bus is used as an example.

As a computer-readable storage medium, the memory 61 may be configured to store a software program, a computer executable program, and a module, such as a program corresponding to the signal generation method in the embodiments of the present application and the module (resource module 201 and carrier module 202) corresponding to the signal generation apparatus in the embodiment of the present application. The processor 60 executes software programs, instructions, and modules stored in the memory 61 to perform functions and data processing of the electronic device, that is, to implement the preceding signal generation method.

The memory 61 may mainly include a program storage region and a data storage region. The program storage region may store an operating system and a program required by at least one function. The data storage region may store data created based on the use of the electronic device. Additionally, the memory 61 may include a high-speed random-access memory and may also include a non-volatile memory, for example, at least one magnetic disk memory, a flash memory, or another non-volatile solid-state memory. In some examples, the memory 61 may also include memories remotely disposed with respect to the processor 60. These remote memories may be connected to the electronic device via a network. Examples of the preceding network include but are not limited to, the Internet, an intranet, a local area network, a mobile communication network, and a combination thereof.

An embodiment of the present application also provides a storage medium containing computer-executable instructions that, when executed by a computer processor, is used for performing a signal generation method.

In an embodiment, the signal generation method includes configuring a signal to occupy at least one time-domain symbol in the time domain and at least one subcarrier in the frequency domain, where the bandwidth in the frequency domain includes N subcarriers, and N is greater than or equal to 1; determining information carried on the N subcarriers.

From the preceding description of embodiments, it is apparent to those skilled in the art that the present application may be implemented by software plus necessary general-purpose hardware or may be implemented by hardware. Based on this understanding, the technical solutions of the present application substantially, or the part contributing to the related art, may be embodied in the form of a software product. The computer software product may be stored in a computer-readable storage medium such as a floppy disk, a read-only memory (ROM), a random-access memory (RAM), a flash memory, a hard disk, or an optical disk of a computer and includes several instructions for causing a computer device (which may be a personal computer, a server, or a network device) to perform the signal generation method in the embodiments of the present application.

It is to be noted that units and modules involved in the embodiments of the preceding apparatus are just divided according to functional logic, and the division is not limited to this, as long as the corresponding functions can be achieved. Additionally, the names of functional units are just intended for distinguishing and are not to limit the scope of the present application.

It is to be understood by those of ordinary skill in the art that some or all operations and apparatus in the preceding method and function modules/units in the device may be implemented as software, firmware, hardware, and suitable combinations thereof.

In the hardware embodiments, the division of the preceding function modules/units may not correspond to the division of physical components. For example, one physical component may have multiple functions, or one function or operation may be performed jointly by several physical components. Some or all physical components may be implemented as software executed by a processor, such as a central processing unit, a digital signal processor, or a microprocessor, may be implemented as hardware, or may be implemented as integrated circuits, such as application-specific integrated circuits. Such software may be distributed on computer-readable media. The computer-readable media may include computer storage media (or non-transitory media) and communication media (or transitory media). As known to those of ordinary skill in the art, the term computer storage media includes volatile and non-volatile as well as removable and non-removable media implemented in any method or technology for storing information (such as computer-readable instructions, data structures, program modules, or other data). The computer storage media include, but are not limited to, a RAM, a ROM, aₙ electrically erasable programmable read-only memory (EEPROM), a flash memory, or other memory technologies, a compact disc read-only memory (CD-ROM), a digital video disc (DVD) or other optical disc memories, magnetic cassettes, magnetic tapes, magnetic disk memories or other magnetic storage apparatuses, or any other medium used for storing the desired information and accessible by a computer. Moreover, as known to those of ordinary skill in the art, the communication media generally include computer-readable instructions, data structures, program modules, or other data in a modulated data signal such as a carrier wave or other transport mechanism and may include any information delivery medium.

The above content, with reference to the drawings, illustrates some embodiments of the present application, but is not intended to limit the scope of the claims of the present application. Any modifications, equivalent substitutions, or improvements made by those skilled in the art without departing from the scope and essence of the present application should fall within the scope of the claims of the present application.

1. A signal generation method, comprising:
configuring a signal to occupy at least one time-domain symbol in a time domain and at least one subcarrier in a frequency domain, wherein a bandwidth occupied by the signal in the frequency domain comprises N subcarriers, and N is greater than or equal to 1; and
determining information carried on the N subcarriers.

2. The method according to claim 1, wherein determining the information carried on the N subcarriers comprises at least one of the following:
N1 subcarriers at an upper boundary of the bandwidth are used as a guard bandwidth, wherein N1 is greater than or equal to 0 and less than or equal to N;
N2 subcarriers at a lower boundary of the bandwidth are used as a guard bandwidth, wherein N2 is greater than or equal to 0 and less than or equal to N;
N3 subcarriers at a center of the N subcarriers are not filled with data or are filled with data of 0, wherein N3 is greater than or equal to 0 and less than or equal to N; or
K subcarriers among the N subcarriers are filled with data, wherein K is greater than or equal to 1 and less than or equal to N.

3. The method according to claim 2, wherein positions of the K subcarriers comprise at least one of the following:
remaining subcarriers after removing the N1 subcarriers and the N2 subcarriers from the N subcarriers; or
remaining subcarriers after removing the N1 subcarriers, the N2 subcarriers, and the N3 subcarriers from the N subcarriers.

4. The method according to claim 2, wherein a method for determining positions of the K subcarriers comprises:
dividing remaining subcarriers after removing the N1 subcarriers and the N2 subcarriers from the N subcarriers into K subcarrier groups, wherein each subcarrier group of the K subcarrier groups comprises G subcarriers, wherein G is an integer greater than or equal to 1; and
selecting one subcarrier from the each subcarrier group of the K subcarrier groups to form the K subcarriers; or
wherein a method for determining positions of the K subcarriers comprises:
dividing the N subcarriers into K subcarrier groups, wherein each subcarrier group of the K subcarrier groups comprises G subcarriers, wherein G is an integer greater than or equal to 1; and
selecting one subcarrier from the each subcarrier group of the K subcarrier groups to form the K subcarriers.

5. (canceled)

6. The method according to claim 4, wherein at least one of the following configurations is satisfied:
subcarriers forming the K subcarriers have a same index in the respective K subcarrier groups,
in a case where a selected subcarrier of the K subcarriers belongs to the N3 subcarriers, the selected subcarrier is not filled with data or is filled with data of 0:
in a case where a selected subcarrier of the K subcarriers belongs to the N1 subcarriers, the selected subcarrier is not filled with data or is filled with data of 0: or
in a case where a selected subcarrier of the K subcarriers belongs to the N2 subcarriers, the selected subcarrier is not filled with data or is filled with data of 0.

7-9. (canceled)

10. The method according to claim 4, wherein in a case where the signal supports at least two subcarrier spacings, a configuration of G comprises that:
the at least two subcarrier spacings comprise f_{sc} and 2⁻ⁿ·f_{sc};
in a case where a subcarrier spacing of the at least two subcarrier spacings is f_{sc} and G is configured as y, G is configured as y·2ⁿ in a case where the subcarrier spacing is 2⁻ⁿ·f_{sc}, wherein y is an integer greater than or equal to 1, and n is an integer greater than or equal to 1.

11. The method according to claim 10, wherein the configuration of G comprises at least one of the following:
in a case where the subcarrier spacing is 30 KHz and G is configured as 1, G is configured as 2 in a case where the subcarrier spacing is 15 KHz; or
in a case where the subcarrier spacing is 60 KHz and G is configured as 1, G is configured as 2 in a case where the subcarrier spacing is 30 KHz, and G is configured as 4 in a case where the subcarrier spacing is 15 KHz.

12. The method according to claim 2, wherein the data filled on the K subcarriers is a sequence S of length 2*M, the sequence S is composed of two sequences each having a length of M, and S=[A_{M}, B_{M}];
wherein A_{M} denotes a first sequence of length M, B_{M} denotes a second sequence of length M, and K=2*M; and
wherein A_{M} and B_{M} comprise at least one of the following:
$${A}_{M} = [ {a}_{0} , {a}_{1} , {a}_{2} , {a}_{3} … , {a}_{M - 1} ] , and {B}_{M} = [ {b}_{0} , {b}_{1} , {b}_{2} , {b}_{3} , … , {b}_{M - 1} ] ;$$
$${A}_{M} = [ {a}_{0} , {a}_{1} , {a}_{2} , {a}_{3} … , {a}_{M - 1} ] , and {B}_{M} = [ - {b}_{0} , - {b}_{1} , - {b}_{2} , - {b}_{3} , … , - {b}_{M - 1} ] ;$$
$${A}_{M} = [ - {a}_{0} , - {a}_{1} , - {a}_{2} , - {a}_{3} … , - {a}_{M - 1} ] , and {B}_{M} = [ {b}_{0} , {b}_{1} , {b}_{2} , {b}_{3} , … , {b}_{M - 1} ] ; or$$
$${A}_{M} = [ - {a}_{0} , - {a}_{1} , - {a}_{2} , - {a}_{3} … , - {a}_{M - 1} ] , and {B}_{M} = [ - {b}_{0} , - {b}_{1} , - {b}_{2} , - {b}_{3} , … , - {b}_{M - 1} ] .$$

13. (canceled)

14. The method according to claim 2, wherein the data filled on the K subcarriers is a sequence S of length 4*M, the sequence S is composed of two sequences each having a length of 2*M, and S=[A_{2*M}, B_{2*M}];
wherein A_{2*M} denotes a first sequence of length 2*M, B_{2*M} denotes a second sequence of length 2*M, and K=4*M; and
wherein A_{2*M} and B_{2*M} comprise at least one of the following:
$${A}_{2 * M} = [ {A}_{M} , {B}_{M} ] , and {B}_{2 * M} = [ - {A}_{M} , {B}_{M} ] ;$$
$${A}_{2 * M} = [ {A}_{M} , {B}_{M} ] , and {B}_{2 * M} = [ - {A}_{M} , - {B}_{M} ] ;$$
$${A}_{2 * M} = [ - {A}_{M} , - {B}_{M} ] , and {B}_{2 * M} = [ - {A}_{M} , {B}_{M} ] ; or$$
$${A}_{2 * M} = [ - {A}_{M} , - {B}_{M} ] , and {B}_{2 * M} = [ {A}_{M} , - {B}_{M} ] .$$

15. (canceled)

16. The method according to claim 2, wherein the data filled on the K subcarriers is a sequence S of length 8*M, the sequence S is composed of two sequences each having a length of 4*M, and S=[A_{4*M}, B_{4*M}];
wherein A_{4*M} denotes a first sequence of length 4*M, B_{4*M} denotes a second sequence of length 4*M, and K=8*M; and
wherein A_{4*M} and B_{4*M} comprise at least one of the following:
$${A}_{4 * M} = [ {A}_{2 * M} , {B}_{2 * M} ] , and {B}_{4 * M} = [ - {A}_{2 * M} , {B}_{2 * M} ] ;$$
$${A}_{4 * M} = [ {A}_{2 * M} , {B}_{2 * M} ] , and {B}_{4 * M} = [ - {A}_{2 * M} , - {B}_{2 * M} ] ;$$
$${A}_{4 * M} = [ - {A}_{2 * M} , - {B}_{2 * M} ] , and {B}_{4 * M} = [ - {A}_{2 * M} , {B}_{2 * M} ] ; or$$
$${A}_{4 * M} = [ - {A}_{2 * M} , - {B}_{2 * M} ] , and {B}_{4 * M} = [ {A}_{2 * M} , - {B}_{2 * M} ] .$$

17. (canceled)

18. The method according to claim 2, wherein the data filled on the K subcarriers is a sequence S of length 2ⁱ⁺²*M, the sequence S is composed of two sequences each having a length of 2ⁱ⁺¹*M, and S=[A₂_{ⁱ⁺¹}_{*M}, B₂_{ⁱ⁺¹}_{*M}];
wherein A₂_{ⁱ⁺¹}_{*M} denotes a first sequence of length 2ⁱ⁺¹*M, and B₂_{ⁱ⁺¹}_{*M} denotes a second sequence of length 2ⁱ⁺¹*M;
wherein K=2ⁱ⁺²*M, i is an integer greater than or equal to 0, and M is an integer greater than or equal to 1; and
wherein A₂_{ⁱ⁺¹}_{*M} and B₂_{ⁱ⁺¹}_{*M}, comprise at least one of the following:
$${A}_{{2}^{i + 1} * M} = [ {A}_{{2}^{i} * M} , {B}_{{2}^{i} * M} ] , and {B}_{{2}^{i + 1} * M} = [ - {A}_{{2}^{i} * M} , {B}_{{2}^{i} * M} ] ;$$
$${A}_{{2}^{i + 1} * M} = [ {A}_{{2}^{i} * M} , {B}_{{2}^{i} * M} ] , and {B}_{{2}^{i + 1} * M} = [ - {A}_{{2}^{i} * M} , - {B}_{{2}^{i} * M} ] ;$$
$${A}_{{2}^{i + 1} * M} = [ - {A}_{{2}^{i} * M} , - {B}_{{2}^{i} * M} ] , and {B}_{{2}^{i + 1} * M} = [ - {A}_{{2}^{i} * M} , {B}_{{2}^{i} * M} ] ; or$$
$${A}_{{2}^{i + 1} * M} = [ - {A}_{{2}^{i} * M} , - {B}_{{2}^{i} * M} ] , and {B}_{{2}^{i + 1} * M} = [ {A}_{{2}^{i} * M} , - {B}_{{2}^{i} * M} ] ,$$
wherein i is an integer greater than or equal to 0.

19. (canceled)

20. The method according to claim 12, wherein A_{M} and B_{M} comprise:
$${A}_{M} = [ {e}^{j {θ}_{1}} {a}_{0} , {e}^{j {θ}_{1}} {a}_{1} , {e}^{j {θ}_{1}} {a}_{2} , {e}^{j {θ}_{1}} {a}_{3} … , {e}^{j {θ}_{1}} {a}_{M - 1} ] ; and$$
$${B}_{M} = [ {e}^{j {θ}_{2}} {b}_{0} , {e}^{j {θ}_{2}} {b}_{1} , {e}^{j {θ}_{2}} {b}_{2} , {e}^{j {θ}_{2}} {b}_{3} , … , {e}^{j {θ}_{2}} {b}_{M - 1} ] .$$

21. The method according to claim 14, wherein A_{2*M} and B_{2*M} comprise:
$${A}_{2 * M} = [ {e}^{j {θ}_{1}} {A}_{M} , {e}^{j {θ}_{2}} {B}_{M} ] , and {B}_{2 * M} = [ {e}^{j {θ}_{3}} {A}_{M} , {e}^{j {θ}_{4}} {B}_{M} ] ;$$
wherein (θ1−θ2)−(θ3−θ4)=Q*180° or |θ1−θ2|−|θ3−θ4|=Q*180°, and Q is an integer.

22. The method according to claim 16, wherein A_{4*M} and B_{4*M} comprise:
$${A}_{4 * M} = [ {e}^{j {θ}_{5}} {A}_{2 * M} , {e}^{j {θ}_{6}} {B}_{2 * M} ] , and {B}_{4 * M} = [ {e}^{j {θ}_{7}} {A}_{2 * M} , {e}^{j {θ}_{8}} {B}_{2 * M} ] ;$$
wherein (θ5−θ6)−(θ7−θ8)=Q*180° or |θ5−θ6|−|θ7−θ8|=Q*180°, and Q is an integer.

23. The method according to claim 18, wherein A₂_{ⁱ⁺¹}_{*M} and B₂_{ⁱ⁺¹}_{*M} comprise at least one of the following:
$${A}_{{2}^{i + 1} * M} = [ {e}^{j {θ}_{1}^{i}} {A}_{{2}^{i} * M} , {e}^{j {θ}_{2}^{i}} {B}_{{2}^{i} * M} ] , and {B}_{{2}^{i + 1} * M} = [ {e}^{j {θ}_{3}^{i}} {A}_{{2}^{i} * M} , {e}^{j {θ}_{4}^{i}} {B}_{{2}^{i} * M} ] ;$$
wherein (θ₁ⁱ−θ₂ⁱ)−(θ₃ⁱ−θ₄ⁱ)=Q*180° or |θ₁ⁱ−θ₂ⁱ|−|θ₃ⁱ−θ₄ⁱ|=Q*180°, and Q is an integer.

24. The method according to claim 18, wherein at least one of the following configurations is satisfied:
the first sequence and the second sequence are a Gray complementary sequence pair;
the first sequence A₂_{ⁱ⁺¹}_{*M}, =[a₀, a₁, a₂, a₃, . . . , a_{P-1}], the second sequence B₂ⁱ⁺¹_{*M}=[b₀, b₁, b₂, b₃, . . . , b_{P-1}], and the first sequence and the second sequence satisfy at least one of the following properties: in a case where j=0, Σₙ₌₀^{P-1}(aₙ·aₙ+bₙ·bₙ)=2P; or in a case where j≠0, Σₙ₌₀^{P-1-j}(aₙ·aₙ₊ⱼ+bₙ·bₙ₊ⱼ)=0 wherein P=2ⁱ⁺¹*M, and i is an integer greater than or equal to 0; or
the first sequence A₂_{ⁱ}_{*M}=[a₀, a₁, a₂, a₃, . . . , a_{L-1}], the second sequence B₂_{ⁱ}_{*M}=[b₀, b₁, b₂, b₃, . . . , b_{L-1}], and the first sequence A₂_{ⁱ}_{*M} and the second sequence B₂_{ⁱ}_{*M} satisfy at least one of the following properties: in a case where j=0, Σₙ₌₀^{L-1}(aₙ·aₙ+bₙ·bₙ)=2L: or
in a case where j≠0, Σₙ₌₀^{L-1-j}(aₙ·aₙ₊ⱼ+bₙ·bₙ₊ⱼ); wherein L=2ⁱ*M, and i is aₙ integer greater than or equal to 0.

25-26. (canceled)

27. The method according to claim 12, wherein in a case where K=2^{y}*M+X, wherein y is an integer greater than or equal to 0, M is an integer greater than or equal to 1, and X is an integer greater than or equal to 1, the method further comprises:
generating a sequence S of length 2^{y}*M and a sequence S_{X} of length X; and
filling the K subcarriers based on the sequence S_{X} and the sequence S.

28. The method according to claim 27, wherein generating the sequence S_{X} of length X comprises at least one of the following:
generating the sequence S_{X} of all zeros of length X;
randomly generating the sequence S_{X} of length X;
generating the sequence S_{X} of length X according to a preset formula;
forming the sequence S_{X} by first X elements in the sequence S;
forming the sequence S_{X} by last X elements in the sequence S; or
forming the sequence S_{X} by selecting X elements from the sequence S; and
wherein filling the K subcarriers based on the sequence S_{X} and the sequence S comprises:
generating a sequence S_{K} of length K, wherein the generation of the sequence S_{K} comprises at least one of the following:
S_{K}=[S, S_{X}]; or
S_{K}=[S_{X}, S].

29. (canceled)

30. An electronic device, comprising:
one or more processors; and
a memory configured to store one or more programs; wherein the one or more programs, when executed by the one or more processors, cause the one or more processors to perform;
configuring a signal to occupy at least one time-domain symbol in a time domain and at least one subcarrier in a frequency domain, wherein a bandwidth occupied by the signal in the frequency domain comprises N subcarriers, and N is greater than or equal to 1; and
determining information carried on the N subcarriers.

31. A non-transitory computer-readable storage medium storing a computer program that, when executed by a processor, causes the processor to perform:
configuring a signal to occupy at least one time-domain symbol in a time domain and at least one subcarrier in a frequency domain, wherein a bandwidth occupied by the signal in the frequency domain comprises N subcarriers, and N is greater than or equal to 1; and
determining information carried on the N subcarriers.
